(19) United States
(12) Patent Application Publication
(10) Pub. No.: US 2020/0260705 A1
(43) Pub. Date: Aug. 20, 2020

(54) CURVED FISHING ROD

(71) Applicant: Chambers Technology Inc., Maple Grove, MN (US)

(72) Inventors: Jeffrey W. Chambers, Maple Grove, MN (US); Bradley T. Chambers, Mackinac Island, MI (US)

(73) Assignee: Chambers Technology Inc., Maple Grove, MN (US)

(21) Appl. No.: 16/794,913

(22) Filed: Feb. 19, 2020

Related U.S. Application Data
(60) Provisional application No. 62/807,297, filed on Feb. 19, 2019.

(51) Int. Cl. A01K 87/00

(52) U.S. Cl. CPC A01K 87/00

(57) ABSTRACT

Fishing rods including a rod body defining a non-linear shape in a normal, un-loaded state.

### CROSS REFERENCE TO RELATED APPLICATIONS

This application claims the benefit of the filing date of U.S. Provisional Patent Application Ser. No. 62/807,297, filed Feb. 19, 2019, entitled “CURVED FISHING ROD”, the entire teachings of which are incorporated herein by reference.

### BACKGROUND

The present disclosure is directed to fishing rods. More particularly, it relates to fishing rods with improved performance.

Basic fishing rod and reel constructions have been known and used by sport anglers for a considerable period of time. As sport fishing has become more sophisticated, modifications of the equipment have become increasingly important in order to optimize one's experience and ability to catch different species of fish under various conditions.

Avid anglers strongly prefer a fishing rod that is light-weight, durable, and exhibits a desired level of action, stiffness or flexibility (or “responsiveness”). For example, the stiffness or flexibility to enable casting and placing a lure in the water at a desired location, and the strength and structural robustness to lift the catch out of the water. The term “action” is used to describe how much of the rod bends or deflects when a force is applied at a tip of the rod. A slow action rod deflects less than one that is a fast or moderate action rod of the same type. The responsiveness of a rod is generally in reference to the ability of the entire rod to flex under load and then return to an original shape or state when the load is removed or released.

A fishing rod typically includes one or more rod bodies carrying line guides (e.g., metal rings) or forming an inner line guide passageway. In some instances, a single, long rod body is provided; with other fishing rod designs, two or more rod bodies are provided and connected to one another. The rod body can be solid or hollow.

Regardless, the single rod body or connected rod bodies extend from a handle or butt end (at which a fishing reel is attached) to a tip end, generally tapering in diameter from the handle end to the tip end. The rod body or rod bodies are normally formed of a reinforced fiber material such as fiberglass or carbon fiber sheets, and are linear or straight in a normal or un-loaded state. While well-accepted, conventional fishing rod body constructions do not meet all performance characteristics desired by skilled anglers.

### SUMMARY

The inventors of the present disclosure have recognized a need to address one or more of the above-mentioned problems.

Some aspects of the present disclosure relate to fishing rods including a rod body. The rod body extends from a handle end to a tip end. In a normal, un-loaded state, the rod body is non-linear in extension between the handle end and the tip end. In some embodiments, the rod body defines one or more bends or curved regions between the handle end and the tip end in the normal or un-loaded state.

Some fishing rods, and particular rod bodies, of the present disclosure can exhibit improved or longer casting properties in some embodiments as compared to conventional fishing rods. For example, the pre-formed bend or curved region can multiply the force applied onto a fishing rod line carried by the rod body with the forward casting motion. These characteristics can, for example, provide for longer casting of the fishing lure as compared to conventional fishing rods.

Alternatively or in addition, the fishing rods, and in particular rod bodies, of the present disclosure can exhibit more accurate casting properties as compared to conventional fishing rods in some embodiments. For example, the added force with the forward casting motion as described above may allow the user to point the tip of the fishing rod at the desired location while requiring less force by the user to access the desired location thereby increasing accuracy of lure delivery as compared to conventional fishing rods.

Alternatively or in addition, the fishing rods, and in particular rod bodies, of the present disclosure can provide an increased ability to retrieve a caught fish as compared to conventional fishing rods in some embodiments. For example, the non-linear shape incorporated into the rod bodies of the present disclosure will inherently generate an additional back force as compared to conventional fishing rods. This additional back force, in turns, lessens the level of force required by the user to retrieve a caught fish.

### BRIEF DESCRIPTION OF THE DRAWINGS

FIG. 1 is a simplified side view of a fishing rod in accordance with principles of the present disclosure;

FIG. 2 is a simplified side view of another fishing rod in accordance with principles of the present disclosure;

FIG. 3 is a simplified side view of another fishing rod in accordance with principles of the present disclosure; and

FIG. 4 is a simplified side view of another fishing rod in accordance with principles of the present disclosure;

### DETAILED DESCRIPTION

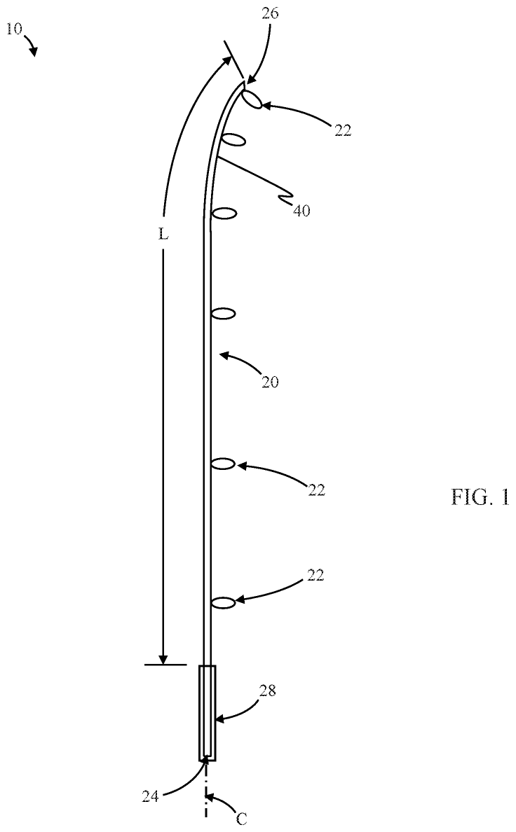

Some aspects of the present disclosure are directed to fishing rods having a pre-set, non-linear or non-straight shape under normal or un-loaded conditions. One example of a fishing rod 10 in accordance with principles of the present disclosure is shown in FIG. 1. The fishing rod 10 includes a rod body 20 and optionally one or more line guides 22. The rod body 20 extends from a handle or grip end 24 to a tip end 26. A handle or grip 28 as is known in the art can be applied or assembled over the rod body 20 adjacent the handle end 24 is generally configured to receive a reel (not shown) as is known in the art. The rod body 20 can be provided as a singular, uninterrupted component, or can consist of two (or more) rod body sections that are separately formed and subsequently assembled. Regardless, a diameter (or maximum transverse dimension with embodiments in which the rod body 20 has a non-circular cross-sectional construction) of the rod body 20 generally tapers in a direction of the tip end 26, and a working length L is defined from the handle 28 to the tip end 26. The line guides 22 are of a type known in the art (e.g., metal rings) attached to and projecting from the rod body 20. Any number of line guides 22 can be provided. The line guides 22 can be spaced at various distances along the rod body 20, and are generally aligned with one another at one “side” of the rod body 20. In some embodiments, a location of the line guides 22 is at a “forward” side of the rod body 20. When provided as part of a fishing rod and reel assembly, a reel is attached to the handle 28 and a fishing line wound about the reel is threaded through the line guides 22. A leading end of the fishing line extends beyond the line guide 22 at the tip end 26 and is fastened to a hook, lure, etc. In yet other embodiments, the fishing rods of the present disclosure can have an internal line guide format (e.g., at least a portion of the rod body 20 is hollow, and the fishing line is interiorly fed through the rod body 20 to the tip end 26); with these and similar embodiments, the line guides 22 can be omitted.

In the view of FIG. 1, the rod body 20 is in a normal or un-loaded state. That is to say, the illustration of FIG. 1 reflects a shape of the rod body 20 as provided to a user, with no casting torque applied at the handle 28, and no load (e.g., a fish caught on the fishing line) applied to the tip end 26 or anywhere else along a length of the rod body 20. With this in mind, the rod body 20 is configured such that in the normal or un-loaded state, a pre-set shape of the rod body 20 is non-linear or non-straight in extension from the handle 28 to the tip end 26. The non-linear construction of the rod body 20 can be described, for example, with reference to a primary centerline C of the rod body 20. The primary centerline C is a linear central axis defined by a portion of the rod body 20. In some embodiments, the primary centerline C is the central axis of the rod body 20 (in the normal or un-loaded state) along at least a majority of the length of the rod body 20. In other embodiments, the primary centerline C is the central axis of the rod body 20 at the handle 28. The non-linear shape of the rod body 20 can be characterized by a central axis of the rod body 20 along at least a section of a length of the rod body 20 deviating from the primary centerline C. For example, with the one embodiment of FIG. 1, at least one curved region 40 is defined along the working length L, with a central axis of the rod body 20 along the curved region 40 representing a deviation from the primary centerline C.

In some embodiments, a uniform radius of curvature is established along the curved region 40, with a shape of the rod body 20 following the uniform radius of curvature to the tip end 26. In other embodiments, a non-uniform radius of curvature can be established. The radius of curvature along the curved region 40 can be selected, for example, in accordance with desired performance characteristics or end use (e.g., a smaller radius of curvature may be more appropriate for long range casting end usages, whereas a larger radius of curvature may be more appropriate for saltwater fishing end usages). While the curved region 40 is shown as being formed proximate the tip end 26, other locations are equally acceptable, and can be selected, for example, in accordance with desired performance characteristics or end uses (e.g., the type of fish intended to be caught, the type of lure to be used, the weight of the fishing line to be used, water conditions or depth at which fishing will occur, etc.). For example, the curved region 40 can be formed intermediate the tip end 26 and the handle 28, proximate the handle 28, etc. Further, while a single curved region 40 is illustrated, in other embodiments, two or move curves can be defined along the length of the rod body 20 (e.g., the rod body 20 can, in extension from the handle 28 to the tip end 26, form a first curved region, followed by a straight or linear region, followed by a second curved region).

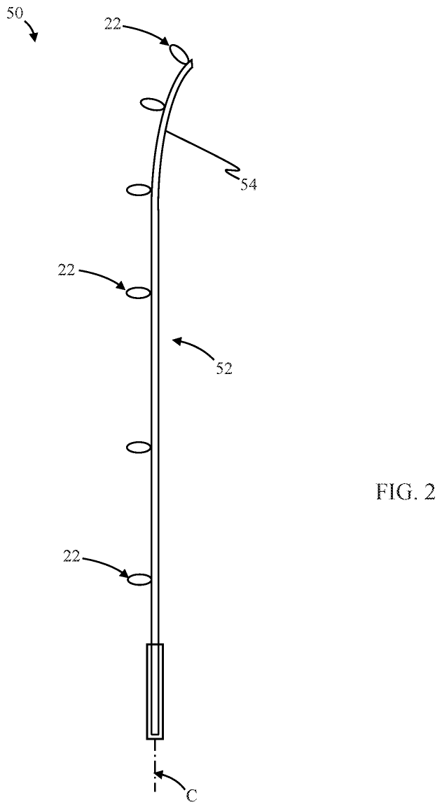

With the non-limiting embodiment of FIG. 1, the curved region 40 is formed to deviate from the primary centerline C in a direction of the “side” of the rod body 20 from which the line guides 22 project. With the configuration of FIG. 1, the rod body 20 can be described as having a “forward” curve or deviation from the primary centerline C (e.g., the curved region 40 curves in a direction of the line guides 22). Other constructions are also envisioned. For example, the curved region 40 can have an arch-like shape, initially extending in a first direction relative to the line guides 22, followed by extension in a second direction, opposite the first direction. FIG. 2 illustrates an alternative embodiment fishing rod 50 that includes a rod body 52 forming, in a normal or un-loaded state, a curved region 54. A direction of the curved region 54 is opposite that of the curved region 40 (FIG. 1), curving in a direction away opposite the line guides 22. With the configuration of FIG. 2, the rod body 52 can be described as having a “rearward” curve or deviation from the primary centerline C.

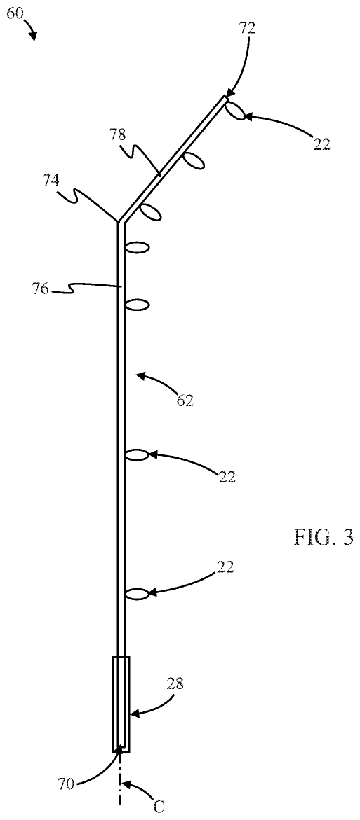

Another embodiment of a fishing rod 60 in accordance with principles of the present disclosure is shown in FIG. 3. The fishing rod 60 can be highly akin to the fishing rod 10 described above, and includes a rod body 62, the line guides 22, and the handle 28. The rod body 62 extends from a handle end 70 to a tip end 72. The handle 28 is mounted over the rod body 62 adjacent the handle end 70, and is configured to promote attachment of a reel (not shown). In the normal or un-loaded state of FIG. 3, a pre-set shape of the rod body 20 is non-linear or non-straight in extension from the handle 28 to the tip end 72. The non-linear construction of the rod body 62 can be described, for example, with reference to a primary centerline C of the rod body 62. The non-linear shape of the rod body 62 can be characterized by a central axis of the rod body 62 along at least a section of a length of the rod body 62 deviating from the primary centerline C. With the one embodiment of FIG. 3, at least one bend 74 is defined along the working length L (identified in FIG. 1), with a central axis of the rod body 62 in extension from the bend 74 (extension in a direction of the tip end 72, or extension in a direction of the handle end 70) representing a deviation from the primary centerline C. For example, the rod body 62 can be described has having a first region 76 immediately “behind” the bend 74 (i.e., from the bend 74 toward the handle end 70) and a second region 78 immediately “ahead” of the bend 74 (i.e., from the bend 74 toward the tip end 72). A central axis defined by the rod body 62 along the second region 78 is non-parallel relative to the primary centerline C. Thus, the bend 74 and the second region 78 represent a deviation from the primary centerline C.

A shape or angle of the bend 74 (e.g., an angle defined by the primary centerline C and the central axis along the second region 78) can be selected, for example, in accordance with desired performance characteristics or end use (e.g., a more severe bend may be more appropriate for long range casting end usages, whereas a slighter bend may be more appropriate for saltwater fishing end usages). While the bend 74 is shown as being formed proximate the tip end 72, other locations are equally acceptable, and can be selected, for example, in accordance with desired performance characteristics or end uses (e.g., the type of fish intended to be caught, the type of lure to be used, the weight of the fishing line to be used, water conditions or depth at which fishing will occur, etc.). For example, the bend 74 can be formed approximately mid-way between the tip end 72 and the handle 28, proximate the handle 28 etc. Further, while a single bend 74 is illustrated, in other embodiments, two or move bends can be defined along the length of the rod body 62 (e.g., the rod body 62 can, in extension from the handle 28 to the tip end 72, form a first bend, followed by a straight or linear region, followed by a second bend).

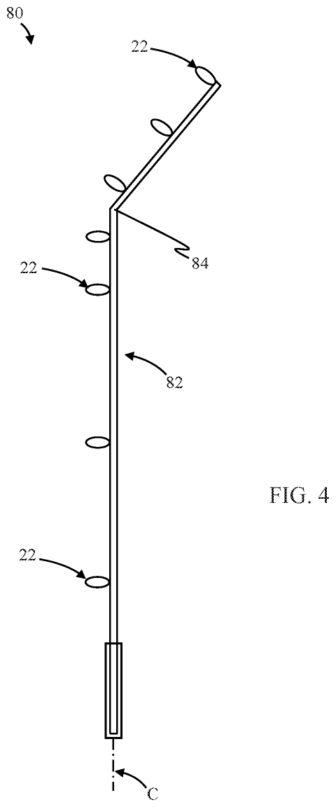

With the non-limiting embodiment of FIG. 3, the bend 74 is formed to deviate from the primary centerline C in a direction of the “side” of the rod body 62 from which the line guides 22 project. With the configuration of FIG. 3, the rod body 62 can be described as having a “forward” bend or deviation from the primary centerline C (e.g., the bend 74 bends in a direction of the line guides 22). Other constructions are also envisioned. FIG. 4 illustrates an alternative embodiment fishing rod 80 that includes a rod body 82 forming, in a normal or un-loaded state, a bend 84. A direction of the bend 84 is opposite that of the bend 74 (FIG. 3), bending in a direction away opposite the line guides 22. With the configuration of FIG. 4, the rod body 82 can be described as having a “rearward” bend or deviation from the primary centerline C.

The rod bodies of the present disclosure (e.g., the rod bodies of FIGS. 1-4) can be formed to have the non-linear shape in the normal or un-loaded condition in various manners. In some embodiments, the rod bodies establish the non-linear shape without the inclusion or provision of a mechanical joint, pivot member, hinge, spring, etc. For example, the rod bodies of the present disclosure can have a continuous, uninterrupted construction from the handle to the tip end. In some embodiments, the rod body can be formed of conventional fishing rod materials (e.g., reinforced fiber glass or carbon fiber) heat set to the non-linear shape. In other embodiments, the rod body includes or incorporates a shape memory member. The shape memory member extends along at least a portion of the working length L, optionally along an entirety of the working length L, and promotes the desired non-linear shape, more consistently maintaining and returning to the selected longitudinal shape or bend with the application and removal of a load at the tip end. Shape memory members of the present disclosure can include a shape memory metal alloy, such as nickel-titanium alloys (e.g., NiTi™ or Nitinol™), copper-zinc-aluminum alloys, copper-aluminum-nickel alloys, iron-manganese-silicon alloys, etc. Other shape memory members of the present disclosure can include a shape memory polymer (e.g., linear block copolymer such a polyurethanes, etc.). The shape memory members of the present disclosure can be provided as a singular structural component, or can be incorporated into a composite structure such as a fiber reinforced polymer composite containing a thin shape memory alloy (or thin shape memory polymer), a shape memory alloy embedded into a fiber material such as carbon fiber or fiber glass, a braided or mesh format, etc. The rod body can be solid in cross-section, or can be tubular.

Although the present disclosure has been described with reference to preferred embodiments, workers skilled in the art will recognize that changes can be made in form and detail without departing from the spirit and scope of the present disclosure.

1. A fishing rod comprising:
a rod body extending from a handle end to a tip end, wherein the rod body has a non-linear shape in extension from the handle end to the tip end in a normal, un-loaded state.

2. The fishing rod of claim 1, wherein the rod body defines a curved region between the handle end and the tip end in the normal, un-loaded state.

3. The fishing rod of claim 1, wherein the rod body defines a bend between the handle end and the tip end in the normal, unloaded state.

4. The fishing rod of claim 1, further comprising line guides projecting from a forward side of the rod body.

5. The fishing rod of claim 4, wherein the rod body defines a deviation from a primary central axis in a direction of the forward side in the normal, un-loaded state.

6. The fishing rod of claim 4, wherein the rod body defines a deviation from a primary central axis in a direction opposite the forward side in the normal, un-loaded state.

7. The fishing rod of claim 1, wherein rod body includes a shape memory member establishing the non-linear shape.

8. The fishing rod of claim 7, wherein the shape memory member comprises a shape memory alloy.

9. The fishing rod of claim 8, wherein the shape memory alloy comprises a nickel-titanium alloy.

10. The fishing rod of claim 7, wherein the shape memory member comprises a shape memory polymer.
